(19) United States
(12) Patent Application Publication
(10) Pub. No.: US 2022/0098376 A1
(43) Pub. Date: Mar. 31, 2022

(54) CELLULOSE NANOFIBER FILM AND METHOD FOR MANUFACTURING THE SAME

(71) Applicants: HYUNDAI MOTOR COMPANY, Seoul (KR); KIA MOTORS CORPORATION, Seoul (KR); UNIVERSITY-INDUSTRY COOPERATION GROUP OF KYUNG HEE UNIVERSITY, Yongin-si (KR)

(72) Inventors: Chae Hwan Hong, Seoul (KR); Jin Woo Choung, Suwon-si (KR); Jungmok You, Yongin-si (KR); Kangyun Lee, Suwon-si (KR)

(73) Assignees: HYUNDAI MOTOR COMPANY, Seoul (KR); KIA MOTORS CORPORATION, Seoul (KR); UNIVERSITY-INDUSTRY COOPERATION GROUP OF KYUNG HEE UNIVERSITY, Yongin-si (KR)

(21) Appl. No.: 17/149,460

(22) Filed: Jan. 14, 2021

(30) Foreign Application Priority Data
Sep. 25, 2020 (KR) 10-2020-0124367

(51) Int. Cl. C08J 5/18; C08B 15/04

(52) U.S. Cl. CPC C08J 5/18; C08J 2301/04; C08B 15/04

(57) ABSTRACT

A method of manufacturing a cellulose nanofiber film includes: oxidation-treating cellulose fibers with TEMPO (2,2,6,6-tetramethylpiperidin-1-yl)oxyl) to prepare a cellulose fiber dispersion; treating the cellulose fiber dispersion with a high pressure homogenizer to defibrate it and to prepare a cellulose nanofiber suspension; and mixing glycerol or a derivative thereof with the cellulose nanofiber suspension, followed by coating and drying the resultant to form a film.

### CROSS-REFERENCE TO RELATED APPLICATION

This application claims priority to and the benefit of Korean Patent Application No. 10-2020-0124367 filed in the Korean Intellectual Property Office on Sep. 25, 2020, the entire contents of which are incorporated herein by reference.

### BACKGROUND

### (a) Field of the Disclosure

The present disclosure relates to a cellulose nanofiber film and a method of manufacturing the same. The cellulose nanofiber film may be applied for a protective film for an automobile part, a protective film of a display device, a large area/high strength flat composite material, a gas separation membrane, and a separation membrane of a rechargeable battery.

### (b) Description of the Related Art

Cellulose obtained from a plant resource is the most abundant natural polymer present on the earth and has merits of excellent mechanical properties and heat resistance and is environmentally friendly. Because of these reasons, cellulose has been researched as a substitute for various petroleum-based synthesis polymers.

More particularly, a method of manufacturing an industrially-applied dry film using cellulose nanofiber suspension has been developed in various fields. The cellulose nanofiber film has a merit of substituting for a transparent polymer because of high dispersibility of the cellulose nanofiber, but it has a limit in producing a thick film in a millimeter level because a strong hydrogen bond between cellulose fibers causes a strong contractile force during a coating and drying process, so that the application thereof is stopped at a packing material, a thin film, and the like.

The coating processes of the cellulose nanofiber suspension which have been researched so far have no results published under the thick condition, but cases of mixing a thin film cellulose nanofiber film and a different type of synthesis polymer in a laminate (plywood) form are known. But the methods have problems of non-uniform quality and a huge deviation in property views of flatness, shrinkage, warpage, and the like of the final dried film.

In addition, the drying films which have been disclosed so far have a size of about a 2×2 cm² level, so there is no appropriate method to attempt to provide a large area film.

### SUMMARY

An embodiment provides a method of manufacturing a cellulose nanofiber film having high heat resistance, excellent mechanical properties such as tensile strength, and excellent transparency; suppressing shrinkage and warpage even if being manufactured in a high thickness and a large area; and achieving high flatness.

Another embodiment provides a cellulose nanofiber film manufactured using the aforementioned manufacturing method.

According to an embodiment, a method of manufacturing a cellulose nanofiber film includes: oxidation-treating cellulose fibers with TEMPO (2,2,6,6-tetramethylpiperidin-1-yl)oxyl) to prepare a cellulose fiber dispersion; treating the cellulose fiber dispersion with a high pressure homogenizer to defibrate it and to prepare a cellulose nanofiber suspension; and mixing glycerol or a derivative thereof with the cellulose nanofiber suspension, followed by coating and drying the resultant to form a film.

In the oxidation-treating, the cellulose fiber may be added to a solution in which sodium hypochlorite (NaClO), sodium bromide (NaBr), and TEMPO are mixed. A catalytic oxidation-treatment may be performed at a pH of about 10 to about 10.5 for about 2 to about 10 hours.

In the defibrating, the cellulose fiber dispersion may be treated once to 10 times at about 40 MPa to about 100 MPa in a high pressure homogenizer.

The cellulose nanofiber suspension may include about 1 wt % to about 3 wt % of the cellulose nanofibers based on a total weight of the cellulose nanofiber suspension.

The glycerol or derivative thereof may include glycerol, triethylene glycol, triacetin, or a combination thereof.

The glycerol or derivative thereof may be added in an amount of about 1 part by weight to about 50 parts by weight based on 100 parts by weight of the dry cellulose nanofiber.

In forming the film, the drying may be performed by semi-drying the cellulose nanofiber film in a thermo-hygrostat having a temperature of about 20° C. to about 60° C. and a relative humidity of about 20% to about 90%.

Forming the film may further include planarizing the semi-dried cellulose nanofiber film by thermal compression at about 25° C. to about 100° C.

According to another embodiment, a cellulose nanofiber film includes cellulose nanofibers laminated in a form including a plurality of pores and a glycerol or a derivative thereof between the cellulose nanofibers. The cellulose nanofiber is a TEMPO-oxidized cellulose nanofiber that includes about 0.1 mmol/g to about 1.5 mmol/g of a carboxyl group or a derivative thereof on the surface.

The cellulose nanofiber film may be manufactured by the above method of manufacturing the cellulose nanofiber film.

A thickness of the cellulose nanofiber film may be greater than or equal to about 200 μm.

A shrinkage rate of the cellulose nanofiber film may be less than about 10%.

The method of manufacturing the cellulose nanofiber film according to an embodiment may achieve high heat resistance, excellent mechanical properties such as tensile strength, and transparency. Even when manufactured in a high thickness and large area, a shrinkage rate and distortion are suppressed, and high flatness is achieved.

### BRIEF DESCRIPTION OF THE DRAWINGS

FIG. 1 is a process flowchart showing a method of manufacturing the cellulose nanofiber film.

FIG. 2 is a photograph of the cellulose nanofiber film manufactured according to Example 1.

### DETAILED DESCRIPTION OF THE EMBODIMENTS

Advantages and characteristics of this disclosure, and a method for achieving the same, should become evident referring to the following embodiments together with the drawings attached hereto. However, the embodiments should not be construed as being limited to the embodiments set forth herein. Unless otherwise defined, all terms used in the specification (including technical and scientific terms) may be used with meanings commonly understood by a person having ordinary knowledge in the art. The terms defined in a generally-used dictionary may not be interpreted ideally or exaggeratedly unless clearly defined. In addition, unless explicitly described to the contrary, the word “comprise,” and variations such as “comprises” or “comprising”, should be understood to imply the inclusion of stated elements but not the exclusion of any other elements.

Further, the singular includes the plural unless mentioned otherwise.

According to an embodiment, a method of manufacturing a cellulose nanofiber film includes oxidation-treating, defibrating, and film-forming processes.

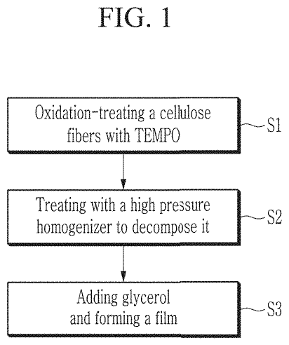

FIG. 1 is a process flowchart showing a method of manufacturing the cellulose nanofiber film. Hereinafter, referring to FIG. 1, the method of manufacturing a cellulose nanofiber film is described in detail.

In the oxidation-treating S1, the cellulose fiber is performed with TEMPO (2,2,6,6-tetramethylpiperidin-1-yl)oxyl) oxidation treatment to provide a cellulose fiber dispersion.

The cellulose fiber may include, for example, a plant-derived fiber, an animal-derived fiber, a microorganism-derived fiber, and the like. These fibers may be used in singularly or in combination according to needs. For example, the cellulose fiber may include a plant-derived fiber (plant fiber), and may include a pulp fiber which is one type of the plant fiber.

The plant fiber may include, for example, wood pulp from hardwood, softwood, and the like, a non-wood pulp made from straw, bagasse, and the like, delinked pulp (DIP) from recycled waste paper, scrap paper, and the like. These plant fibers may be used singularly or in combination.

The wood pulp may be, for example, a chemical pulp such as hardwood kraft pulp (LKP), softwood kraft pulp (NKP), and the like, mechanical pulp (TMP), delinked pulp (DIP), and the like. These wood pulps may be used singularly or in combination.

The oxidation-treating may be performed by adding the cellulose fiber into a solution in which sodium hypochlorite (NaClO), sodium bromide (NaBr), and TEMPO are mixed.

A solvent for preparing the oxidation-treating solution may include a polar solvent, for example, distilled water, methanol, ethanol, isopropanol, butanol, or a combination thereof.

The oxidation-treating may be TEMPO-oxidation-treating using a catalyst of TEMPO (2,2,6,6-tetramethylpiperidin-1-yl)oxyl). The TEMPO, which is one type of catalyst, is available in the market and has characteristics of being water soluble and safe.

The TEMPO is oxidized to a nitrosonium ion under a predetermined condition to be reacted with a hydroxy group (—OH) at the 6th carbon (Ce) of the cellulose fiber to substitute the hydroxy group with a carboxyl group (—COOH) or a carboxylate group (—COOM, where M is an alkaline metal or an alkaline-earth metal) which is a derivative thereof.

The oxidation-treating may be performed at a pH of about 9.5 to about 10.5, for example, a pH of about 10 to about 10.5, for about 2 hours to about 10 hours, for example, about 2 hours to about 4 hours. When the oxidation-treating is performed at a pH of less than about 9.5, the reaction rate may be decreased while the concentration of the hydroxy group (OH⁻) is lowered, and the oxidation decomposition reaction due to a hypohalite is accelerated to lower a molecular weight of the cellulose fiber; on the other hand, when the pH is greater than about 10.5, the polymer chain may be decomposed due to the hydroxyl group (OH⁻, hydroxide). When the oxidation-treating time is less than 2 hours, the substitution may be incompletely performed.

In the defibrating process (S2), the obtained cellulose fiber dispersion is treated with a high pressure homogenizer to prepare a cellulose nanofiber suspension.

The high pressure homogenizer may be used to let the cellulose fiber dispersion to forward collision on a straight line. The device may include, for example, a microfluidizer or a wet jet-mill as a forward collision high pressure homogenizer, and the like. Two upper flow paths are formed to make the pressed cellulose fiber dispersion to forwardly collide in a merge area in the device. In addition, the cellulose fiber dispersion collides in the merge area, and the collided cellulose fiber dispersion is discharged from a lower flow path. The lower flow path is disposed vertically with respect to the upper flow path, and a T-type flow path is formed by the upper flow path and the lower flow path. When using the device, the energy of the device is maximally converted to collision energy, so as to more effectively defibrate the cellulose fiber.

The pressure of the high pressure homogenizer may be about 40 MPa to about 100 MPa, for example, about 95 MPa to about 100 MPa. When the pressure of the high pressure homogenizer is less than about 40 MPa, the rate of providing nanofiber may be decreased since it may not overcome bonds among the TEMPO-oxidized cellulose fiber bundle. However, when the pressure of the high pressure homogenizer is greater than about 100 MPa, the TEMPO-oxidized cellulose nanofiber may break to shorten a length (polymerization degree) or to be carbonized by a high temperature.

The treating with the high pressure homogenizer may be repeated for one time to about 10 times, for example, about 4 times to 10 times.

The cellulose nanofiber suspension may include the cellulose nanofiber at about 1 wt % to about 3 wt % based on a total weight of the cellulose nanofiber suspension. When the amount of the cellulose nanofiber is less than about 1 wt %, the drying time is excessively prolonged until providing a sheet having a required thickness, so that efficiency such as cost, energy, and the like may be deteriorated. However, when the amount of the cellulose nanofiber is greater than about 3 wt %, it is aggregated as a gel because of a high viscosity, so that a uniform solution phase is not maintained, causing process trouble.

The cellulose nanofiber obtained by defibrating the same using the TEMPO-oxidation-treating and the high pressure homogenizer is a nano-sized fiber having a diameter (fiber diameter) of less than or equal to about 50 nm and a length (fiber length) of less than or equal to about 1 μm.

Meanwhile, the cellulose nanofiber is an environmentally friendly nanofiber having excellent mechanical properties and transparency, therefore having merits of substituting for a transparent polymer. But the film made of the cellulose nanofiber is generally formed in a thickness of less than or equal to about a 50 μm level in a dried state. At this thickness level, phenomena of shrinkage and warpage are not outstanding. However, when the film is formed in a thickness of greater than or equal to about 100 μm, shrinkage and warpage occur during the drying process. The applications thereof are thereby limited to a thin film level such as a package material.

Specifically, the cellulose nanofiber has many hydroxyl groups (—OH) on the surface. Also, in the TEMPO-oxidation treated cellulose nanofiber, a hydroxyl group (—OH) of the 6th carbon is substituted with a carboxyl group (—COOH) or a carboxylate group (—COOM, M is alkaline metal or an alkaline-earth metal) which is a derivative thereof, and it is an early phase of a water-based solution paste and is then converted to a dried film shape through the drying process. In the drying process, the cellulose nanofiber or the TEMPO-oxidation-treated cellulose nanofiber undergoes shrinkage by the strong bond between the surface hydroxyl group and the carboxyl group or the carboxylate group. The degree of shrinkage is negligible in the thin film, but when a thick film shape is required, it is difficult to provide a required shape due to the strong shrinkage.

Thereby, according to the present disclosure, in the coating process (S3), glycerol or a derivative thereof is mixed into the suspension and then coated and dried to provide a film. Thus, the TEMPO-oxidation treated cellulose nanofiber may suppress the shrinkage and the warpage in the drying process even if the film is formed in a thicker thickness than the above-mentioned thickness.

Specifically, the glycerol or a derivative thereof is favorable for a hydrogen bond with a carboxyl group and a hydroxyl group of the TEMPO-oxidation treated cellulose nanofiber and a Van der Waals interaction. Simultaneously, it has high miscibility with water and also a low molecular weight, so as to act as a lubricant between fibers to provide flexibility, more particularly, to prevent a strong hydrogen bond between the TEMPO-oxidation treated cellulose nanofibers. Thus, the shrinkage and the warpage in the coating process may be suppressed, and the quality uniformity of the final product may be improved.

The glycerol, which is trivalent alcohol, may be obtained together with a fatty acid, for example, by hydrolyzing oils. Specifically, the glycerol or the derivative thereof may include glycerol, triethylene glycol, triacetin (triacetin or glyceryl triacetate, glyceryl triacetate), or a combination thereof. More particularly, when using the glycerol derivative including triacetin or an ester substituent, the shrinkage and the warpage may be further suppressed in the coating of a thick film through the hydrogen bond with a carboxyl group of the TEMPO-oxidation treated cellulose nanofiber or a derivative thereof and a Van der Waals interaction.

The glycerol or a derivative thereof may be added at about 1 part by weight to about 50 parts by weight, for example, about 10 parts by weight to about 25 parts by weight, based on 100 parts by dry weight of the cellulose nanofiber. When the glycerol content is less than about 1 part by weight, it may not provide a semi-dried film in the thermo-hygrostat since the glycerol has relatively low moisture absorption and retention and may cause shrinkage of the cellulose nanofiber. However, when the glycerol content is greater than about 50 parts by weight, it may have weak properties due to high moisture absorbance and retention, so the shape hardly remains.

For providing a film, the drying may be semi-drying the cellulose nanofiber film in a thermo-hygrostat at a temperature of about 20° C. to about 60° C., for example, about 40° C. to about 50° C., and at relative humidity of about 50% to about 90%, for example, about 80% to about 90%. When the drying temperature is less than about 20° C., the drying speed may be delayed, but when the drying temperature is greater than about 60° C., the glycerol may be discolored or shrunk by moisture loss at the high temperature.

The providing a film is performed by thermo-compressing the semi-dried cellulose nanofiber film at about 25° C. to about 70° C., for example, about 55° C. to about 65° C. to keep a flat film shape. When the thermo-compressing temperature is less than about 25° C., the time for final drying may be prolonged, but when the thermo-compressing temperature is greater than about 70° C., the glycerol may be discolored by the high temperature.

According to another embodiment, a cellulose nanofiber film manufactured by the aforementioned method is provided.

Thus, the cellulose nanofiber film includes TEMPO-oxidized cellulose nanofibers, which are laminated in a form including a plurality of pores, and includes a glycerol or a derivative thereof disposed between the cellulose nanofibers.

The cellulose nanofiber may include about 0.1 mmol/g to about 1.5 mmol/g of a carboxyl group or a derivative thereof as the hydroxyl group is substituted with a carboxyl group or a derivative thereof according to the TEMP-oxidation treatment. When an amount of the carboxyl group is less than about 0.1 mmol/g, the repulsive force between fibers is too low to obtain a uniform dispersion. However, when the amount of the carboxyl group is greater than or equal to about 1.5 mmol/g, it is excessively oxidized to break a bond of the molecular chain to lower a polymerization degree (to shorten a length of the cellulose fiber).

In addition, the cellulose nanofiber film is coated by mixing the cellulose nanofiber suspension obtained by using the TEMPO-oxidation treatment and the high pressure homogenizer and the glycerol or the derivative thereof. So, even if it is formed at a thickness of greater than or equal to about 200 μm, for example, about 800 μm to about 1 mm, it may have a shrinkage rate of less than about 10%, for example, about 7% to about 10% during the drying.

The cellulose nanofiber film may be variously applied to automobile parts and industrial usages. Specifically, it may be applied as a protective film protecting from scratches on a new car. When the film is mixed with a predetermined polymer resin and cured, it may be applied for a protector of a display device such as a navigator in a vehicle.

In addition, the cellulose nanofiber film may be applied for producing a flat composite material product having a large area and high strength.

Furthermore, the cellulose nanofiber film may be also applied in a field such as a separation membrane for separating a predetermined component of a mixed gas, a separation membrane of a rechargeable battery, and the like.

Hereinafter, specific examples of the disclosure are presented. However, the examples described below are for illustrative purposes only, and the scope of the disclosure is not limited thereto.

### Preparation Example: Manufacture of Cellulose Nanofiber Film

### Example 1

A micro-sized cellulose fiber is added in a solution in which sodium hypochlorite (NaClO), sodium bromide (NaBr), and TEMPO are dissolved and oxidized by a catalyst to provide a cellulose fiber dispersion. In this case, it is reacted for 2 hours while adjusting pH to 10.

Then the oxidized solution is removed through centrifugation (4000 rpm, 10 minutes), and a TEMPO-oxidized cellulose fiber is re-dispersed in distilled water to provide a TEMPO-oxidized cellulose fiber solution. Through 10 repeated treatments in a 100 MPa high pressure homogenizer, the micro-sized fiber is converted to a nano-sized fiber. Then big-size particles, which are not converted yet to nano-sized fibers are removed through centrifugation (4000 rpm, 10 minutes) to provide a transparent cellulose nanofiber suspension (2 wt % of cellulose nanofiber).

0.5 g of glycerol is mixed with 100 mL of the cellulose nanofiber suspension prepared using the TEMPO-oxidation and the high pressure homogenizer (25 parts by weight based on 100 parts by weight of dry cellulose nanofiber). Then vapor in the solution is removed in a vacuum chamber and coated on a mold having an area of 90 cm² and a water solvent is dried in a thermo-hygrostat at 40° C. and a relative humidity of 90%.

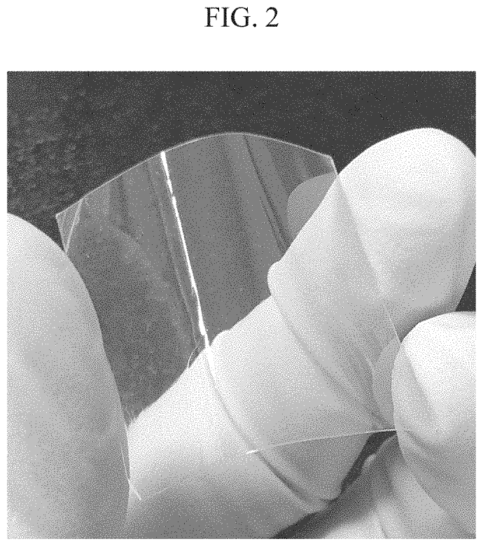

Semi-dried cellulose nanofiber film is thermo-compressed at 60° C. and smoothly dried to provide a cellulose nanofiber film having a thickness of 200 μm. FIG. 2 shows a photograph of the obtained cellulose nanofiber film.

### Examples 2-5 and Comparative Examples 1-3

Cellulose nanofiber films are obtained in accordance with the same procedure as in Example 1, except that the manufacturing conditions are changed as shown in Table 1.

TABLE 1

| | | | | | | Comp. | Comp. | Comp. |
|---|---|---|---|---|---|---|---|---|
| | Ex. 1 | Ex. 2 | Ex. 3 | Ex. 4 | Ex. 5 | Ex. 1 | Ex. 2 | Ex. 3 |
| Mold area | 90 | 90 | 90 | 90 | 90 | 90 | 90 | 90 |
| (cm²) | | | | | | | | |
| Suspension | 2 | 2 | 2 | 2 | 2 | 2 | 2 | 2 |
| (nanofiber | wt %/ | wt %/ | wt %/ | wt %/ | wt %/ | wt %/ | wt %/ | wt %/ |
| content/ | 100 | 100 | 100 | 200 | 400 | 100 | 100 mL | 100 |
| suspension | mL | mL | mL | mL | mL | mL | | mL |
| volume) | | | | | | | | |
| Glycerol | 0.5 g | 1 g | 2 g | 1 g | 2 g | — | — | 0.5 g |
| Drying | 40° C. | 40° C. | 40° C. | 40° C. | 40° C. | 60° C. | 40° C. | 25° C. |
| temperature | | | | | | | | |
| Drying | 90% | 90% | 90% | 90% | 90% | 40% | 90% | 90% |
| humidity | | | | | | | | |
| Thermal | 60° C. | 60° C. | 60° C. | 60° C. | 60° C. | 60° C. | 60° C. | — |
| compression | | | | | | | | |
| temperature | | | | | | | | |

### EXPERIMENTAL EXAMPLES

The cellulose nanofiber films obtained from the examples and comparative examples are measured for a length change before and after the drying to provide a shrinkage rate (%). A distortion is examined with the naked eye. The results are shown in the following Table 2.

TABLE 2

| | | | | | | Comp. | Comp. | Comp. |
|---|---|---|---|---|---|---|---|---|
| | Ex. 1 | Ex. 2 | Ex. 3 | Ex. 4 | Ex. 5 | Ex. 1 | Ex. 2 | Ex. 3 |
| Shrinkage | <10% | <8% | <7% | <10% | <10% | >50% | >50% | >30% |
| rate (%) | | | | | | | | |
| Distortion | None | None | None | None | None | Very | Very | Severe |
| (Examined | | | | | | severe | severe | |
| with naked | | | | | | | | |
| eye) | | | | | | | | |

Referring to Table 2, the cellulose nanofiber films manufactured according to the examples were suppressed from shrinkage and distortion even when manufactured with a high thickness and a large area compared with the cellulose nanofiber films manufactured according to the comparative examples.

While this disclosure has been described in connection with what are presently considered to be practical example embodiments, it is to be understood that the disclosure is not limited to the disclosed embodiments. On the contrary, the disclosure is intended to cover various modifications and equivalent arrangements included within the spirit and scope of the appended claims.

What is claimed is:

1. A method of manufacturing a cellulose nanofiber film, the method comprising:
oxidation-treating cellulose fibers with TEMPO (2,2,6,6-tetramethylpiperidin-1-yl)oxyl) to prepare a cellulose fiber dispersion,
treating the cellulose fiber dispersion with a high pressure homogenizer to defibrate the cellulose fiber dispersion and to prepare a cellulose nanofiber suspension, and
mixing glycerol or a derivative thereof with the cellulose nanofiber suspension, followed by coating and drying the resultant to form a film.

2. The method of claim 1, wherein in the oxidation-treating, the cellulose fiber dispersion is added to a solution in which sodium hypochlorite (NaClO), sodium bromide (NaBr), and TEMPO are mixed, and a catalytic oxidation-treatment is performed at a pH of about 10 to about 10.5 for about 2 to about 10 hours.

3. The method of claim 1, wherein in defibrating the cellulose fiber dispersion, the cellulose fiber dispersion is treated once to 10 times at about 40 MPa to about 100 MPa in the high pressure homogenizer.

4. The method of claim 1, wherein the cellulose nanofiber suspension comprises about 1 wt % to about 3 wt % of the cellulose nanofibers based on a total weight of the cellulose nanofiber suspension.

5. The method of claim 1, wherein the glycerol or derivative thereof comprises glycerol, triethylene glycol, triacetin, or a combination thereof.

6. The method of claim 1, wherein the glycerol or derivative thereof is added in an amount of about 1 part by weight to about 50 parts by weight based on 100 parts by weight of the dry cellulose nanofiber.

7. The method of claim 1, wherein in forming the film, the drying is performed by semi-drying the cellulose nanofiber film in a thermo-hygrostat having a temperature of about 20° C. to about 60° C. and a relative humidity of about 20% to about 90%.

8. The method of claim 1, wherein the film is formed by planarizing the semi-dried cellulose nanofiber film by thermal compression at about 25° C. to about 100° C.

9. The method of claim 1, wherein the cellulose nanofiber film comprises:
cellulose nanofibers laminated in a form comprising a plurality of pores, and
glycerol or a derivative thereof between the cellulose nanofibers, and wherein the cellulose nanofibers are TEMPO-oxidized cellulose nanofibers that comprise about 0.1 mmol/g to about 1.5 mmol/g of a carboxyl group or a derivative thereof on the surface.

10. The method of claim 1, wherein a shrinkage rate of the cellulose nanofiber film is less than about 10%.

11. A cellulose nanofiber film, comprising:
cellulose nanofibers laminated in a form comprising a plurality of pores; and
glycerol or a derivative thereof between the cellulose nanofibers,
wherein the cellulose nanofibers are TEMPO-oxidized cellulose nanofibers that comprise about 0.1 mmol/g to about 1.5 mmol/g of a carboxyl group or a derivative thereof on the surface.

12. The cellulose nanofiber film of claim 11, wherein a thickness of the cellulose nanofiber film is greater than or equal to about 200 μm.

13. The cellulose nanofiber film of claim 11, wherein a shrinkage rate of the cellulose nanofiber film is less than about 10%.
